(19) United States
(12) Patent Application Publication
(10) Pub. No.: US 2026/0292273 A1
(43) Pub. Date: Sep. 24, 2026

(54) PICTURE QUALITY ADJUSTMENT FOR CONNECTED VIDEO DISPLAY

(71) Applicant: Roku, Inc., San Jose, CA (US)

(72) Inventor: Il Jun Lee, Austin, TX (US)

(73) Assignee: Roku, Inc., San Jose, CA (US)

(21) Appl. No.: 19/082,666

(22) Filed: Mar. 18, 2025

(51) Int. Cl. H04N 21/234; H04N 21/422; H04N 21/4223

(52) U.S. Cl. CPC H04N 21/234; H04N 21/42202; H04N 21/4223

(57) ABSTRACT

A display system adjusts picture quality settings to provide an improved and more consistent viewer experience. Different display manufacturers have different default picture quality settings, and a content display device learns the settings of a connected display and adjusts the picture to reduce variation across different displays. A mobile device may be used to capture environmental data (e.g., ambient light), and a content display device adjusts picture quality based on the captured data.

### TECHNICAL FIELD

This disclosure relates generally to display devices and systems, and more specifically, to techniques for adjusting display settings to improve viewer experience.

### BRIEF DESCRIPTION OF THE DRAWINGS

Embodiments will be readily understood by the following detailed description in ‎conjunction with the accompanying drawings. To facilitate this description, like reference ‎numerals designate like structural elements. Embodiments are illustrated by way of ‎example, and not by way of limitation, in the figures of the accompanying drawings.

FIGURE(FIG.) 1 depicts a block diagram of a system environment for media delivery, according to some embodiments of the disclosure.

FIG. 2 is a block diagram of exemplary electronic system to implement picture quality adjustment according to some embodiments of the disclosure.

FIG. 3 is a block diagram of a picture adjustment module according to some embodiments of the disclosure.

FIG. 4 is a flow diagram for content handling and display that includes picture quality adjustment, according to some embodiment of the disclosure.

FIG. 5 is a flow diagram illustrating exemplary operations for determining a picture quality adjustment based on metadata from a connected display, according to some embodiment of the disclosure.

FIG. 6 depicts a block diagram of a system environment for media delivery that includes mobile devices, according to some embodiments of the disclosure.

FIG. 7 is a block diagram of a mobile device that can be used to capture data for determining picture quality adjustments, according to some embodiments of the disclosure.

FIGS. 8A and 8B are two example illustrations of a mobile device detecting a display surface, according to some embodiments of the disclosure.

FIGS. 9A, 9B and 9C are three example display screens of a mobile device providing instructions to a user to assist in a calibration procedure, according to some embodiments of the disclosure.

FIG. 10 is a flow diagram for determining a picture quality adjustment based on environmental data captured by a mobile device, according to some embodiments of the disclosure.

FIG. 11 depicts a block diagram of an exemplary computing device, according to some embodiments of the disclosure.

### DETAILED DESCRIPTION

### Overview

Image data is typically broken down into smaller elements called pixels. Each pixel represents one color in a specific location of the screen. An image presented on a full high-definition screen (i.e., 1920 x 1080) will contain millions of these pixels. The pixels are often encoded in terms of an RGB triplet. In an RGB triplet, each component corresponds to red, green, or blue; each component can vary from zero to a defined maximum value. A higher value indicates a higher brightness for a particular color within the pixel.

Picture Quality (PQ) settings refer to various adjustments and configurations that can be made on displayed content. PQ settings play a role in how colors, contrast, brightness, sharpness, and motion are displayed. Certain PQ settings are applied at a display device, such as a TV, monitor, or projector. Other PQ settings are applied at a content source (e.g., a set-top box, streaming stick, etc.) that transmits content to a display device.

In some cases, a user may manually adjust one or more PQ settings based on their own preferences. Typical user-adjustable display settings include brightness, contrast, color temperature, and sharpness. Contrast describes the difference between the darkest and lightest parts of an image. A higher contrast enhances the distinction between light and dark areas, which can improve image depth and clarity. Color temperature describes the warmth or coolness of the display's color tone; a warm temperature causes images to appear more yellow, while a cool temperature causes images to appear more blue. Sharpness modifies the clarity and detail of the image. A higher sharpness can make edges appear crisper, but a high sharpness can also introduce visual artifacts. Other PQ settings may include gamma, backlight settings, motion smoothing, motion enhancement, local dimming, high dynamic range (HDR) settings, noise reduction, and white balance. In some cases, certain PQ settings may be user configurable, while others are set by the manufacturer and are not adjustable.

Different PQ settings result in different visual outputs based on the same image data. For example, if two displays have different PQ settings, they may display the same set of image data very differently, which can lead to an inconsistent display of content. Most display devices have PQ settings pre-configured, and there is a lot of variation between different display devices. For example, one manufacturer may set their devices’ PQ settings to provide a cooler color temperature, while another manufacturer sets their devices’ PQ settings to provide a warmer color temperature. Even if a display device provides manual configurability, many users do not make manual adjustments. In some cases, a display device may only make certain PQ settings adjustable. In other cases, a display device may make a larger number of PQ settings available; in such cases, users may be confused or overwhelmed by the settings, and may typically leave them unchanged, or only change more familiar settings.

Content providers or content platforms may prefer to have a consistent output across different devices. For example, a content provider may want their content to have a consistent color temperature across different devices, rather than varying across devices based on the device manufacturers’ preferences. As described herein, a content delivery device (e.g., a set-top box, projector, streaming device, etc.) may receive metadata from a connected display device that is correlated to PQ settings of the display. For example, the content delivery device may receive information about the manufacturer and model of the connected display device. As noted above, a particular manufacturer may be known to set their display devices with a particular set of PQ settings. Based on the metadata, the content delivery device may retrieve picture quality adjustment information, and prior to transmitting content for display on the display device, the content delivery device applies a picture adjustment to the image data. By using different picture quality adjustments for different manufacturers (and/or, in some cases, different display models), content delivery devices can output more consistent images across different display devices.

To further improve users’ viewing experiences, image settings may be adjusted based on the environment around the display, e.g., ambient light levels and/or color tones. For example, in a low-light environment, such as a dedicated media room, a lower overall brightness may be preferred, while in an area with a lot of ambient light, a higher brightness may provide a better experience. As another example, the color or tone of ambient lighting in the room (e.g., based on light bulbs, wall colors, etc.) can affect the perceived image from a display device, and the image settings may be adjusted based on the ambient tones or colors. In various embodiments, PQ settings of the display device and/or PQ settings applied at a content delivery device may be adjusted based on the environment of the display device.

As described herein, a calibration procedure for determining PQ settings for a particular environment may use a second device, such as a mobile phone or other mobile device, to capture data about a viewing environment. The viewing environment includes a display device (e.g., a television or a projector directed at a projection surface), and the viewing environment may further include a content delivery device (e.g., a set-top box, projector, streaming device, etc.). In some cases, the display device may include functionality of a content delivery device, e.g., if the display device is a smart TV. During the calibration procedure, the mobile device or display device may instruct a user to position the mobile device in a particular way, e.g., a certain distance from the display surface, or at a typical position from where the user watches the display. The mobile device or display device may further instruct the user to orient the mobile device in a particular way, e.g., facing the display, perpendicular to the display, etc. In some embodiments, the display device outputs a calibration screen. After the devices have been properly set up for calibration, one or more sensors on the mobile device (e.g., cameras and/or ambient light sensors) capture environmental data, and a picture quality adjustment is determined based on the environmental data. The content delivery device may apply the determined picture quality adjustment to content for display on the display device. For example, the content delivery device may adjust content prior to transmitting it to a display device. Alternatively or in addition, the content delivery device may instruct an integrated display or a connected display to adjust PQ settings of the display itself.

### Exemplary system environment for media delivery

FIG. 1 depicts a block diagram of a system environment 100 for media delivery, according to some embodiments of the disclosure. FIG. 1 includes a set of content delivery devices 110A, 110B, and 110C, jointly referred to as content delivery devices 110 or singularly as content delivery device 110. FIG. 1 further includes Internet 120, server 130, and content store 140. Each of content delivery devices 110, as well as server 130 and content store 140, provides a connection to the Internet 120, so that content delivery devices 110, server 130, and content store 140 may communicate. FIG. 1 further includes two display devices 115A and 115B, which are coupled to content delivery devices 110A and 110B, respectively.

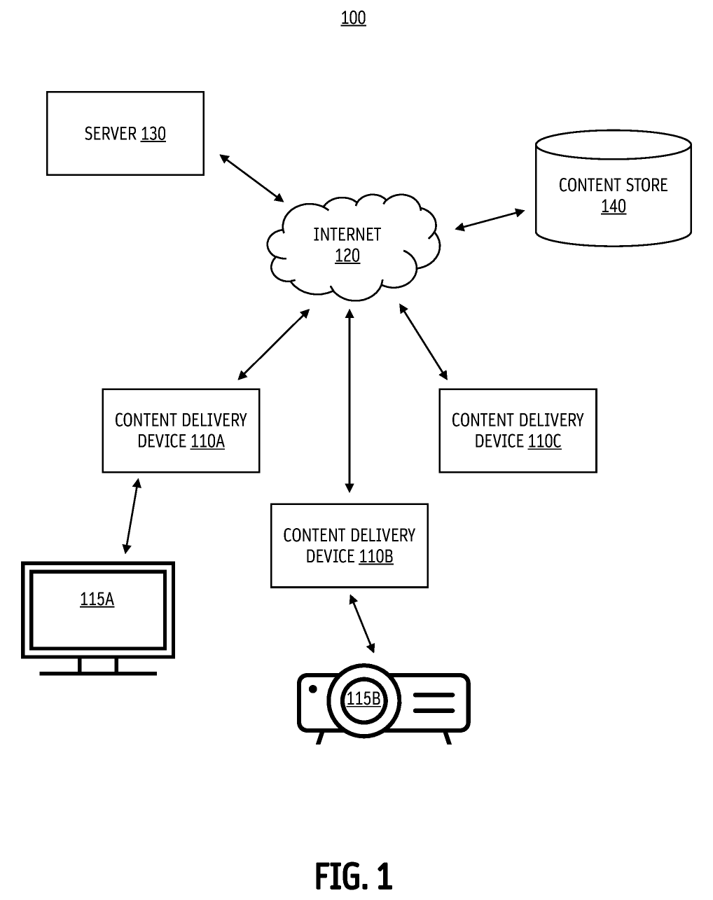

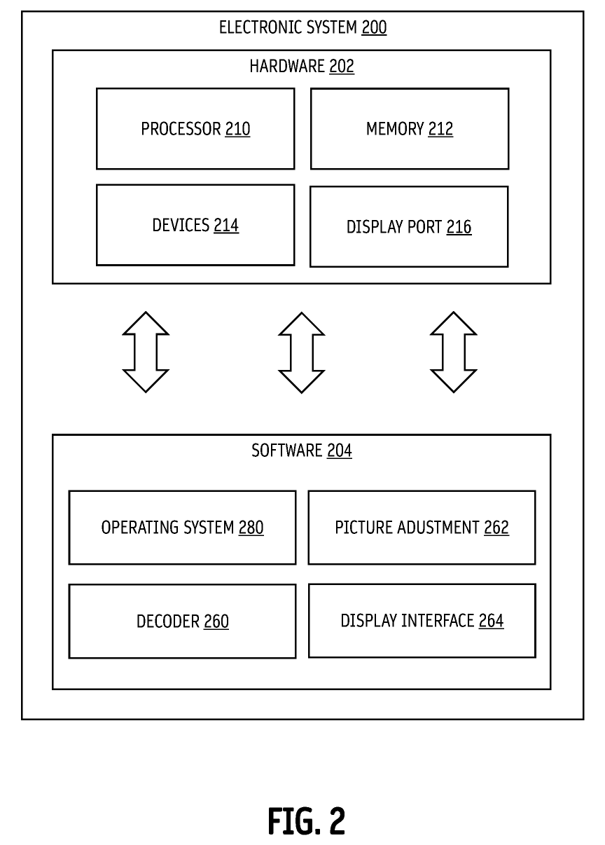

A content delivery device 110 may include hardware and software. Hardware can include physical components of the content delivery device 110. For example, hardware may include a processor, a memory, a network adapter, other communication devices, cryptography accelerator, decoder, light-emitting device, sensors, input device, output device, media card reader, identity module, etc. Software can include instructions, data, and/or programs that can be executed by the processor to perform one or more tasks and/or to manipulate one or more components in the hardware. Software can include an operating system and one or more applications. FIG. 2, described below, is a block diagram illustrating certain features of a content delivery device 110 and that includes hardware and software.

In some embodiments, a content delivery device 110 is a streaming device for streaming content, such as video content and/or audio content. In some embodiments, one or more of the content delivery devices 110 may be a small form-factor device, such as a dongle or a stick. In some embodiments, one or more of the content delivery devices 110 may be a box that can be connected to a display. Display devices 115A and 115B illustrate two examples of connected displays. Specifically, display device 115A is a television and display device 115B is a projector. Each of the display devices 115A and 115B may be connected to the respective content delivery device 110A and 110B by a high-definition multimedia interface (HDMI) cable, a video graphics array (VGA) connection, a DisplayPort connection, a universal serial bus (USB) interface, or another suitable connection or interface for coupling a display to another device.

In some embodiments, one or more of the content delivery devices 110 may be a display device that includes built-in content delivery functionality, such as a smart TV or connected TV. Content delivery device 110C, which does not have a connected display device, is an example of a display device that includes built-in content delivery functionality (e.g., built-in streaming).

Display devices 115 and/or integrated displays of content delivery devices 110 may have one or more default PQ settings. Display devices 115 and/or integrated displays of content delivery devices 110 may have configurable PQ settings, e.g., adjustable brightness, color temperature, contrast, etc. For example, to adjust brightness, a display device 115 may include a backlight that can be dimmed, or individual light sources (e.g., LED pixels) may have variable brightness. As noted above, other PQ settings may be implemented at the content delivery devices 110.

Server 130 may be related to one or more of content delivery devices 110. For example, server 130 may provide data to one or more of content delivery devices and/or receive data from one or more of content delivery devices. Server 130 may control content delivery to content delivery devices 110, e.g., server 130 may operate a content delivery platform accessed by content delivery devices 110. For example, server 130 may provide or enable a user interface on a content delivery device 110 through which a user may request content (e.g., streaming media content) via the Internet 120. Server 130 may return the requested content to the requesting content delivery device 110. In some embodiments, content may be stored on content store 140, and server 130 instructs content store 140 to transmit content to content delivery device 110.

In some embodiments, server 130 stores content received from a content provider on content store 140. In some embodiments, a content provider makes content stored on content store 140 available to users of server 130; the content provider may instruct server 130 to direct content delivery devices 110 to content store 140 to obtain content, for example. In such cases, the content itself may not pass through server 130.

As described herein, in some embodiments, content delivery devices 110 may adjust content received from content store 140 based on a picture quality setting prior to transmitting the content a connected display device 115, or an integrated display device, for display. For example, content delivery device 110A or 110B may adjust content for display on display device 115A or 115B based on characteristics of display device 115A or 115B. As another example, content delivery devices 110 may adjust content for display based on an environment of the display, e.g., as determined using a calibration procedure. In some embodiments, a content delivery device 110 may instruct an integrated display device or a connected display device to adjust the display’s PQ settings, e.g., to change the display’s PQ settings from a default setting for that display device, or to adjust the display’s PQ settings based on the environment of the display.

### Exemplary electronic system

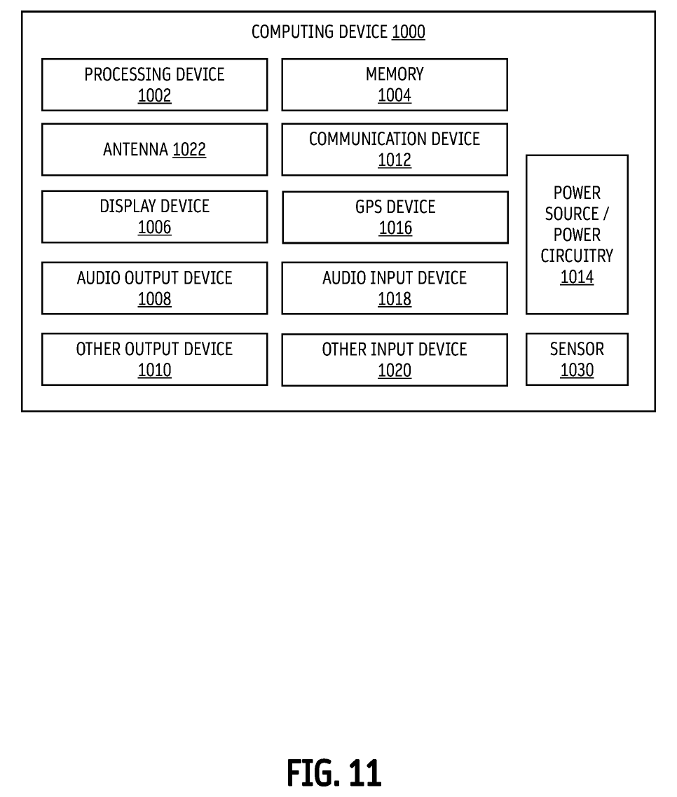

FIG. 2 is a block diagram of electronic system 200 to implement picture quality adjustment according to some embodiments of the disclosure. Electronic system 200 may be an example of a content delivery device 110. Electronic system 200 may in some cases be in the form of a computing device 1100 of FIG. 11. Electronic system 200 may include hardware 202 and software 204. Hardware 202 can include physical components of electronic system 200. Hardware 202 may include processor 210, memory 212, one or more devices 214, and a display port 216. Examples of the one or more devices 214 can include a communication device (e.g., a Wi-Fi adapter or Ethernet adapter), communication interface/controller, cryptography accelerator, decoder, light-emitting device, sensors, input device, output device, media card reader, identity module, etc.

Processor 210 may be any of the processing devices described in relation to FIG. 11. Processor 210 may be a component of a system on a chip (SoC) that also includes various interfaces (e.g., one or more memory interfaces, communications interfaces, etc.) and/or additional components, such as a graphics processing unit (GPU). The SoC may be coupled to memory 212, and/or the SoC may include an integrated memory. Memory 212, or a separate memory (e.g., a memory component of processor 210 or the SoC, or a separate memory component coupled to processor 210) may include other forms of memory, as described with respect to FIG. 11. Memory 212 may store picture quality settings, e.g., PQ settings or PQ adjustments as determined and used as described herein.

Display port 216 provides a physical interface to a connected display, e.g., the display device 115A or display device 115B. For example, display port 216 may be an HDMI port, VGA port, DisplayPort, or USB port. In some embodiments, display port 216 may connect to an integrated display (e.g., in the example of content delivery device 110C). Alternatively, rather than including display port 216, electronic system 200 may include a display screen, such as a LCD, a light-emitting diode display, or a flat panel display, a heads-up display, a computer monitor, a projector, a touchscreen display, for example.

Software 204 can include instructions, data, and/or programs that can be executed by a processor (e.g., processor 210) to perform one or more tasks and/or to manipulate one or more components in hardware 202. Software 204 can include operating system 280 and one or more applications. Here, software 204 further includes decoder 260, picture adjustment 262, and display interface 264. Software 204 may include additional applications or modules not illustrated in FIG. 2.

Decoder 260 receives an encoded video stream and generates video frames. Decoder 260 may perform decompression, e.g., according to a compression standard used for video transmission. In some embodiments, decoder 260 may be broken into multiple applications or include multiple sub-modules, e.g., a first module or application for decompression, a second module or application for gamma decoding, etc.

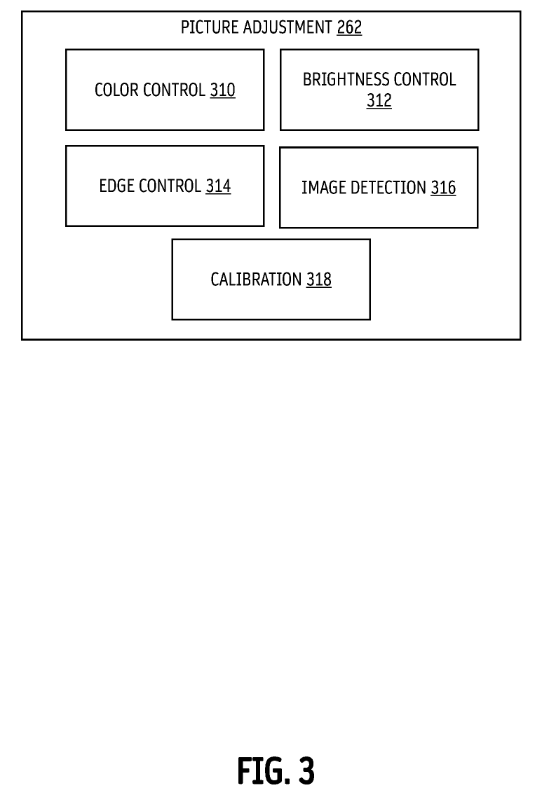

Picture adjustment 262 adjusts image data for display. In particular, picture adjustment 262 may adjust image data (e.g., video frames) output by decoder 260 before electronic system 200 transmits the image data to a display via display port 216. Picture adjustment 262 may retrieve one or more picture adjustment settings stored in memory 212. The picture adjustment settings may be determined by a calibration procedure involving electronic system 200, a display screen, and a mobile device. Alternatively or additionally, the picture adjustment settings may be determined based on metadata about the connected display. In some embodiments, picture adjustment 262 is implemented using one or more application programming interfaces (APIs) configured to adjust decoded image data based on a set of picture quality settings. A block diagram illustrating example aspects of picture adjustment 262 is shown in FIG. 3, described below.

Display interface 264 enables communication between electronic system 200 and a display device. In some embodiments, display interface 264 processes data received at display port 216 from a connected display. Display interface 264 may further transmit data to a display via display port 216. For example, display interface 264 may transmit the decoded and adjusted image data for display through the display port 216. In some embodiments, electronic system 200 may be capable of changing PQ settings of a display, e.g., a connected display 115 or an integrated display of electronic system 200. For example, display interface 264 may transmit PQ settings relating to, e.g., brightness, contrast, or color temperature, to a connected or integrated display device. The PQ settings may be determined by a calibration procedure or based on data about the connected display, as described herein.

Operating system 280 may include software that manages hardware 202 and other resources in software 204. Operating system 280 can provide services for one or more applications. Operating system 280 can act as an intermediary between an application and hardware 202. Operating system 280 can implement one or more of: process management, memory management, device management, security, and input/output management. Operating system 280 may include one or more libraries corresponding to the one or more services. A library may include a well-defined API. A library may include corresponding implemented functions of the API. An API may include specifications for applications to make a request or call a function. For example, a library may include an API for using a device of the one or more devices 214. An application can open a library to start a service. The application can call a function defined in the library to perform an operation using the service.

### Exemplary picture adjustment module

FIG. 3 is a block diagram of a picture adjustment module, e.g., picture adjustment 262, according to some embodiments of the disclosure. Picture adjustment 262 includes color control 310, brightness control 312, edge control 314, image detection 316, and calibration 318. In some embodiments, picture adjustment 262 may not include one or more of the illustrated modules. In some embodiments, picture adjustment 262 may include one or more additional modules, e.g., modules for controlling other types of picture quality settings such as noise, motion smoothing, motion enhancement, white balance, sharpness, etc. The picture adjustments described with respect to FIG. 3 are merely exemplary.

Color control 310 adjusts coloration of image data. For example, color control 310 may adjust color temperature of the image data, e.g., giving the image a more yellow or “warmer” tone, or giving the image a more blue or “cooler” tone. Color correction of image data can counteract a color temperature setting of a display device. For example, if a particular television manufacturer prefers a warmer tone and configures the television’s PQ settings to output images with a warmer tone, but a content provider prefers neutral coloration, color control 310 may adjust the image data to cool the color temperature. When the television then warms the image data that was cooled by color correction, the resulting output has a neutral tone. As another example, color control 310 may adjust individual colors, e.g., intensity of red, green, or blue in RGB pixel data. In some embodiments, color control 310 may work with image detection 316 to adjust color of certain areas of an image, e.g., to adjust skin tone coloration for areas of the screen identified by image detection 316 as including human skin.

Brightness control 312 controls brightness within the image data. The brightness of an image can be adjusted in several ways, e.g., by adjusting a light source (e.g., the backlight of a display or the lamp power of a projector), or by adjusting brightness of RGB pixels, e.g., by increasing brightly on all three of the RGB channels. Within picture adjustment 262, brightness control 312 adjusts the brightness within the image data, e.g., by adjusting brightness of the RGB pixels. In some embodiments, brightness control 312 may additionally or alternatively adjust gamma, contrast, or other PQ settings that may alter the perceived brightness of the screen. In other embodiments, these may be handled by separate modules.

Edge control 314 controls the sharpness or definition of objects within an image. For example, edge control 314 can be used to increase or reduce blurriness or softening that can occur along edges of objects within the image. Edge control 314 adjustments can refine the overall clarity and crispness of an image. Edge control 314 can work in tandem with image detection 316, which may identify the edges of objects within the image. For example, image detection 316 may Sobel filters, Canny edge detection, or other algorithms to detect high-contrast boundaries within the image; these edges may be processed by edge control 314 to adjust sharpness in areas of the detected edges. In some embodiments, image detection 316 may identify certain areas that contain specific types of images, e.g., people or human faces, and edge control 314 and/or another module (e.g., brightness control 312) may adjust the image to increase visibility of these areas. Settings for edge control 314 may be selected based on viewing distance, screen size, or other factors.

In some embodiments, picture adjustment 262 may adjust the picture quality settings based on content type. For example, picture adjustment 262 may apply different settings for movies than for television content. As another example, for sports content, image detection 316 may identify a sports ball within the image, and edge control 314, brightness control 312, or other modules may enhance visibility of the ball.

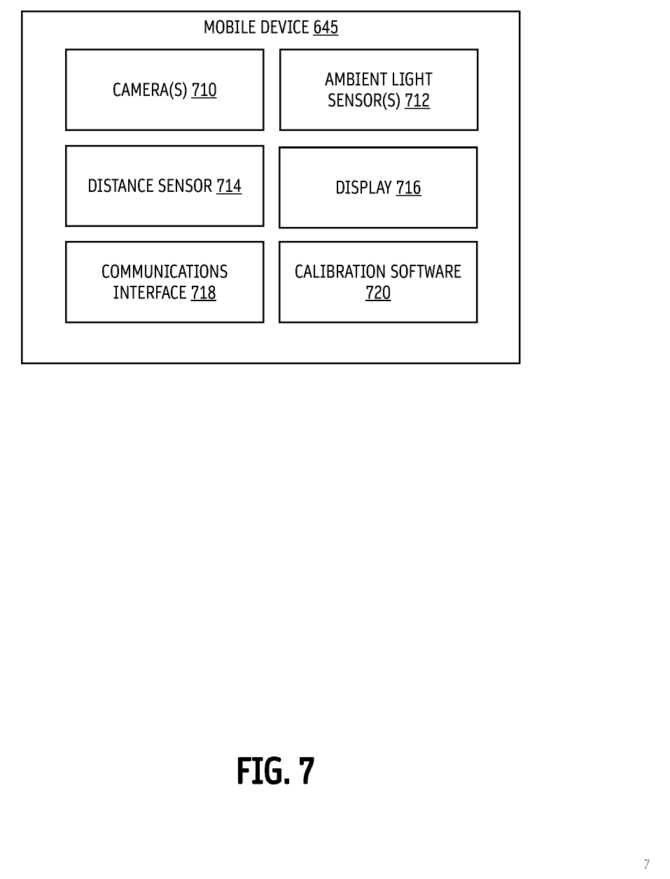

Picture adjustment 262 further includes a module for calibration 318. Calibration 318 may determine picture adjustment settings applied by color control 310, brightness control 312, edge control 314, or other adjustment modules. Calibration may involve collection and/or processing of environmental data, e.g., a calibration procedure may involve a mobile device to capture data describing light in the environment of a display surface. An example calibration procedure is described with respect to FIGS. 7-10.

### Exemplary flow diagram for content handling and display

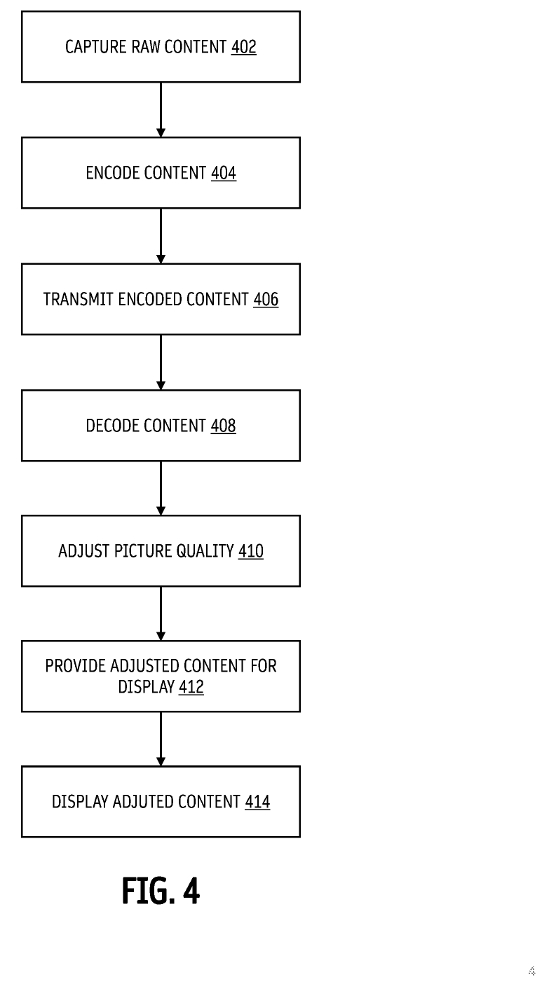

FIG. 4 depicts a flow diagram for content handling and display that includes picture quality adjustment, according to some embodiment of the disclosure. In 402, a first device (e.g., a camera) captures raw content, which includes brightnesses measured using a linear luminance scale.

In 404, a video encoder (e.g., a video encoder on the camera, or a separate video encoder processing content received from the camera) encodes the content. The content may be color encoded according to any suitable standard (e.g., sRGB, Rec.709, etc.). Additional encoding standards, such as H.26x or MPEG video encoding, may be applied to prepare the content for transmission.

In 406, a content source transmits the encoded content to a device, such as content delivery device 110 or electronic system 200. For example, the content may be transmitted from server 130 or content store 140 to content delivery devices 110 over a wired or wireless connection, as described with respect to the communication device 1112 of FIG. 11.

In 408, the content recipient, e.g., electronic system 200, decodes the content using an applicable decoding standard, e.g., MPEG or H.26x.

In 410, the content recipient, e.g., electronic system 200, applies one or more picture quality adjustments to the decoded content. For example, picture adjustment 262 may adjust color, brightness, edge control, or other picture quality characteristics to the decoded content, e.g., as described with respect to FIG. 3.

In 412, the content recipient (e.g., electronic system 200) transmits the adjusted content for display. For example, content delivery device 110A transmits the adjusted content to display device 115A, or set of content delivery devices 110B transmits the adjusted content for projection by display device 115B.

In 414, the display device displays the adjusted content. For example, display device 115A outputs the received adjusted content on the display screen, or display device 115B projects the received adjusted content onto a projection surface. In some embodiments, display device 115 makes additional picture quality adjustments. As noted above, in some embodiments, a display device may make a picture quality adjustment based on instructions from the content delivery devices 110. In other embodiments, adjustments made in 410 may counteract picture quality adjustments made at a display device 115.

### Exemplary flow diagram for determining a PQ adjustment based on display metadata

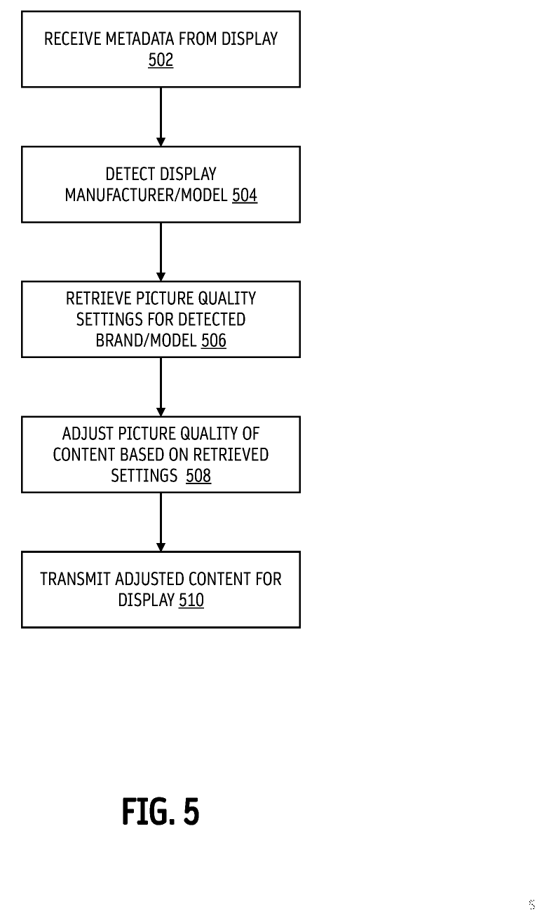

FIG. 5 is a flow diagram illustrating exemplary operations for determining a picture quality adjustment based on metadata from a connected display, according to some embodiment of the disclosure.

In 502, electronic system 200 receives metadata describing a display from a display connected to electronic system 200. For example, if display device 115A is connected to content delivery device 110 through display port 216, the display port 216 receives metadata from display device 115A and passes the metadata to display interface 264. Metadata may be Extended Display Identification Data (EDID) or enhanced EDID (E-EDID). EDID provides information about the display's characteristics, such as manufacturer name and serial number, product type, phosphor or filter type (e.g., chromaticity data), timings supported by the display, display size, luminance data, and pixel mapping data. Other formats may be used, such as DisplayID. In other embodiments, other metadata transmitted from the display device 115 to the content delivery device 110 may be used, e.g., Consumer Electronics Control (CEC) data, Digital Living Network Alliance (DLNA) data, or metadata in other standards or communication protocols. Furthermore, in some embodiments, the metadata describing the display may be obtained outside of the connection between display device 115 and content delivery device 110. For example, a user may input information describing the display device 115, e.g., in a user interface provided by content delivery device 110 (e.g., a configuration user interface output by content delivery device 110 on display device 115), or a user interface on a mobile device (e.g., the mobile device 645, described below).

In 504, electronic system 200 detects a manufacturer and/or model of the connected display. As noted above, EDID may include manufacturer name, serial number, and product type (e.g., product model). Picture adjustment 262 or display interface 264 may extract the manufacturer and/or model from the EDID or other received metadata.

In 506, electronic system 200 retrieves picture quality settings for the detected manufacturer and/or model. For example, picture adjustment 262 may transmit the manufacturer and model information to server 130, which returns picture quality settings specific to the manufacturer and, in some cases, model. Server 130 may have picture quality settings (e.g., inputs to a PQ adjustment API) specifically tuned for different display hardware, so that across different displays, the content delivery platform provides a consistent experience. For example, for a first manufacturer that sets their display devices at a warmer color temperature, the picture quality adjustment settings may be selected to cool the image data, while for a second manufacturer that sets their display devices at a cooler temperature, the picture quality adjustment settings may be selected to warm the image data.

In 508, electronic system 200 adjusts picture quality of content based on the retrieved settings. For example, picture adjustment 262 applies the retrieved picture quality settings to content for display on a display device. As described with respect to FIG. 4, electronic system 200 may adjust the picture quality of the content after receiving the content from a content source (e.g., server 130 or content store 140) and decoding the content. Picture adjustment 262 may adjust color (e.g., color temperature), brightness, edges, or other picture quality characteristics, as described above.

At 510, electronic system 200 transmits the adjusted content for display on the display device. As noted above, in some instances, display device performs its own PQ adjustment to the content. For two content delivery devices 110 connected to two different display devices (e.g., display devices from different manufacturers), the adjustments at picture adjustment 262 intended to provide a more uniform output between the two display devices, even if they have different native PQ settings.

### Exemplary system environment for media delivery with mobile devices

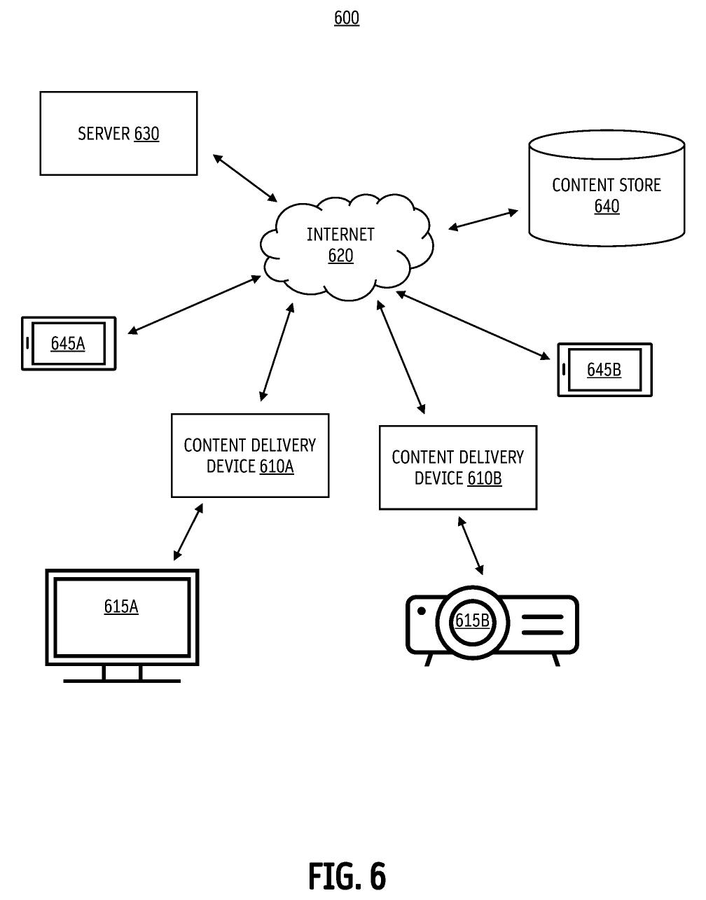

FIG. 6 depicts a block diagram of a system environment 600 for media delivery, according to some embodiments of the disclosure. The system environment 600 is similar to the system environment 100, except that system environment 600 further includes mobile devices which may be used by user of content delivery devices. FIG. 6 includes a set of content delivery devices 610A and 610B, which are similar to the content delivery devices 110A and 110B of FIG. 1 and may include features of electronic system 200, described above with respect to FIGS. 2 and 3. FIG. 6 further includes Internet 620, which is similar to internet 120; server 630, which is similar to server 130; and content store 640, which is similar to content store 140. FIG. 6 further includes two display devices 615A and 615B, which are coupled to content delivery devices 610A and 610B, respectively; the display devices 615A and 615B are similar to the display devices 115A and 115B of FIG. 1. FIG. 6 also includes mobile devices 645A and 645B, referred to jointly as mobile devices 645.

Mobile devices 645 may be any handheld or mobile computer system, e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc. Certain features and functionalities of an example mobile device 645 are described below with respect to FIG. 7.

Mobile device 645A may be associated with content delivery device 610A, and mobile device 645B may be associated with content delivery device 610B. For example, a user may sign into an account associated with the content delivery platform on mobile device 645A and also on content delivery device 610A. As another example, the user may use mobile device 645A to scan a QR code displayed by content delivery device 610A to associate mobile device 645A with content delivery device 610A. In some embodiments, content delivery device 610A and mobile device 645A may communicate over a local network, e.g., a WiFi network or over a Bluetooth connection. Mobile device 645B may be associated with content delivery device 610B in a similar manner.

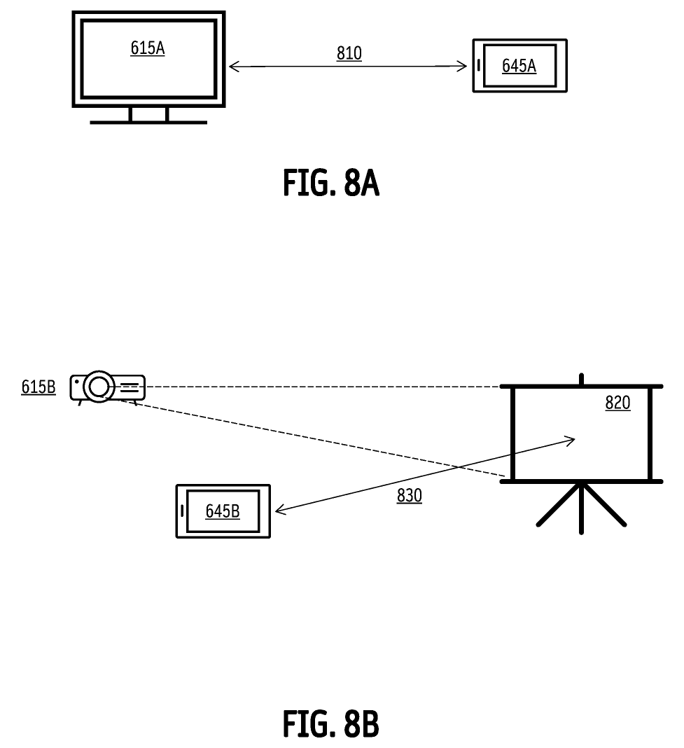

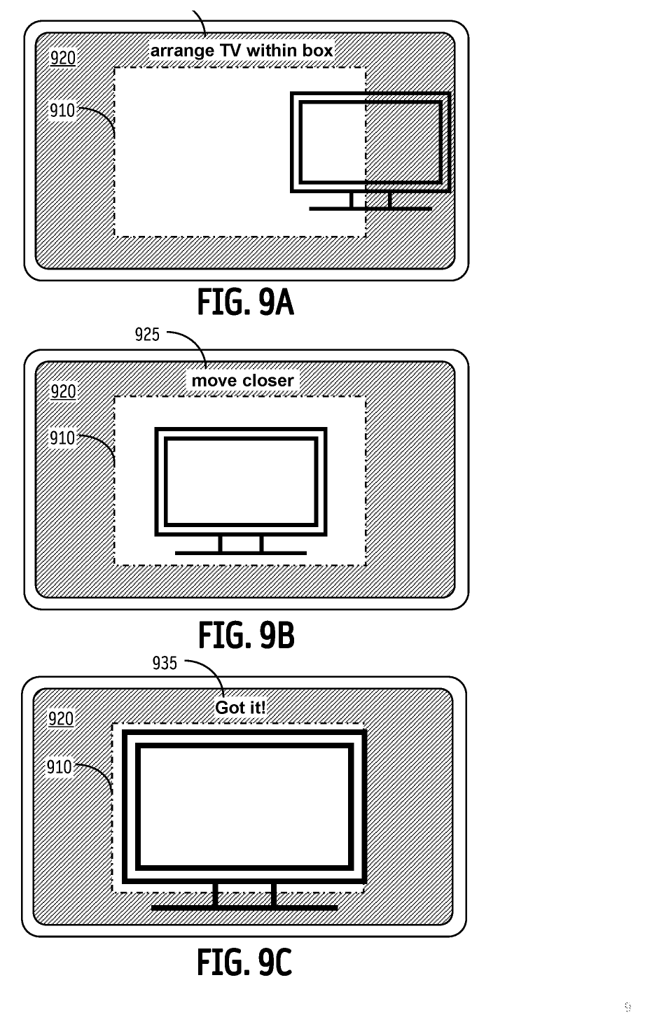

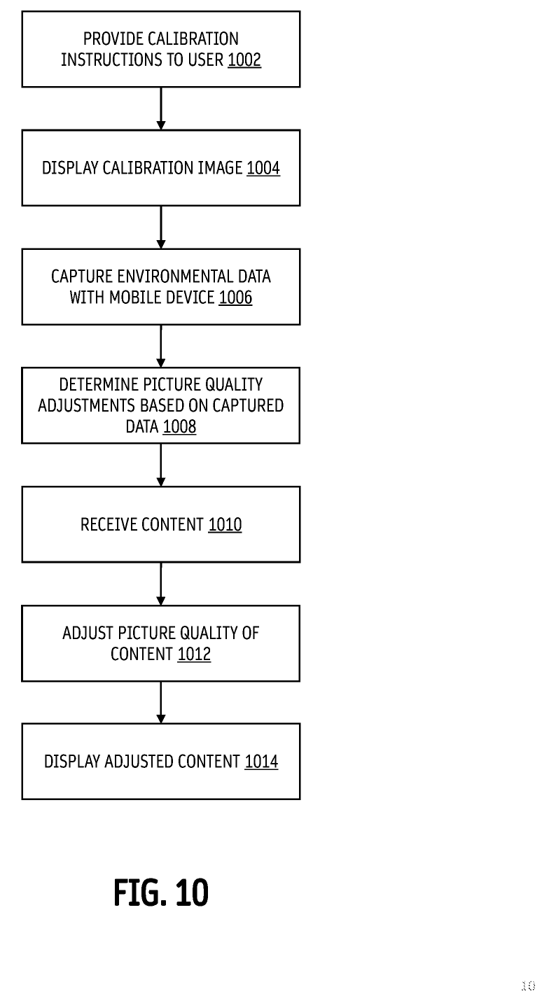

Mobile device 645 may be used in tandem with content delivery device 610 to calibrate one or more picture quality settings of content delivery device 610 and/or display device 615. Certain features and functionalities of an example mobile device 645 are described below with respect to FIG. 7. Two example arrangements of mobile devices 645, content delivery devices 610, and display surfaces are shown in FIGS. 8A and 8B. Example display screens of a mobile device used in a calibration procedure are shown in FIGS. 9A-9C. A flow diagram for determining a picture quality adjustment is shown in FIG. 10.

### Exemplary mobile device for picture quality calibration

FIG. 7 is a block diagram of a mobile device (e.g., one of mobile devices 645A and 645B, and referred to generally as mobile device 645) that can be used to capture data for determining picture quality adjustments, according to some embodiments of the disclosure. Mobile device 645 may in some cases be in the form of a computing device 1100 of FIG. 11. Mobile device 645 may include hardware and software, e.g., as described with respect to FIG. 2.

Mobile device 645 includes one or more cameras 710, an ambient light sensor 712, a distance sensor 714, a display 716, a communications interface 718, and calibration software 720. In some embodiments, mobile device 645 may include multiple ambient light sensors 712 (e.g., one on the front and one on the back), multiple distance sensors 714, and/or multiple displays 716. Communications interface 718 may include multiple communications modes (e.g., WiFi, Bluetooth, cellular network, etc.), or mobile device 645 may include multiple communications interfaces 718 implementing the different communication modes.

Cameras 710 are imaging devices to capture photos and/or videos. Many modern mobile devices are equipped with multiple lenses, such as wide-angle, ultra-wide, and telephoto lenses, and may have cameras in multiple positions, e.g., on both a front and a back side. The camera 710 can provide image data that may be used to analyze the light intensity in a scene, e.g., in an environment surrounding mobile device 645. The image data may also be analyzed (e.g., by calibration software 720) to identify one or more objects in the vicinity of mobile device 645, e.g., as described with respect to FIGS. 9A-9C.

Ambient light sensor 712 is a small device that measures the surrounding light conditions. Ambient light sensor 712 typically works using a photodiode or a phototransistor that detects light and converts the detected light into an electrical signal. Ambient light sensor 712 may be used to adjust a brightness setting for the display 716 of mobile device 645, e.g., to optimize screen visibility and battery efficiency. As described herein, at least one of camera 710 and ambient light sensor 712 can provide environmental or ambient light data used by calibration software 720 and/or picture adjustment 262 to determine picture quality adjustment settings.

Distance sensor 714 measures how far an object is from mobile device 645. Distance sensor 714 may use, for example, ultrasonic, infrared, or time-of-flight (ToF) sensors to determine the distance between mobile device 645 and surrounding objects. For instance, a ToF sensor works by emitting infrared light and measuring the time it takes for the light to bounce back from an object, giving an accurate distance reading. In some embodiments, distance sensor 714 may leverage one or more cameras 710 in combination with other sensors, e.g., ToF sensors, for more precise measurements, or to associate a measured distance with a particular object. As described herein, in some embodiments, distance sensor 714 can provide a distance to a display surface that can be used by calibration software 720 and/or picture adjustment 262 to determine picture quality adjustment settings.

Display 716 is an integrated display screen of mobile device 645. Display 716 may, for example, output images detected by one or more cameras 710. Display 716 may output a user interface from calibration software 720 during a calibration process.

Communications interface 718 enables communication between mobile device 645 and at least one of server 130 and content delivery device 610. For example, data captured by one or more of one or more cameras 710, ambient light sensor 712, and distance sensor 714 may be transmitted from mobile device 645 via communications interface 718 to server 130, which can provide the data, or information derived from the data (e.g., picture quality adjustment settings), to content delivery device 610. Alternatively, the captured data may be transmitted directly from mobile device 645 to content delivery device 610, e.g., via a local WiFi network or Bluetooth connection.

Calibration software 720 on mobile device 645 may work together with calibration 318 of picture adjustment 262 to determine picture quality adjustment settings for content delivery device 110. For example, calibration software 720 may be application provided by server 130 that outputs a calibration user interface on display 716. The application may provide additional features, e.g., content discovery, control, or display. In some embodiments, calibration software 720 may be a web-based interface accessed through a browser operating on mobile device 645. Example user interfaces provided by calibration software 720 are shown in FIGS. 9A-9C.

### Exemplary display surface detection

FIGS. 8A and 8B are two example illustrations of a mobile device detecting a display surface, according to some embodiments of the disclosure. In each of FIGS. 8A and 8B, a mobile device 645 is positioned a distance (810 or 830) away from a display surface. If display device 615 includes a display screen (e.g., display device 615A, which may be a television, for example), as in FIG. 8A, the screen of display device 615 is the display surface. If display device 615 does not include a display screen (e.g., display device 615B, which is a projector), a surface on which light from display device 615B is projected is the display surface. For example, FIG. 8B includes a projection screen 820, which is an example of a display surface. Alternative display surfaces include walls, sheets, or any other suitable flat surface onto which images are projected.

In FIG. 8A, display device 615A is located a distance 810 from mobile device 645A. Camera 710 of mobile device 645A may capture an image of a field of view of the camera, where the field of view includes display device 615A. Distance sensor 714 may determine distance 810 between mobile device 645A and display device 615A.

In FIG. 8B, projection screen 820 is located a distance 830 from mobile device 645B. Camera 710 of mobile device 645B may capture an image of a field of view of the camera, where the field of view includes projection screen 820. Distance sensor 714 may determine distance 830 between mobile device 645B and projection screen 820.

In each of FIGS. 8A and 8B, mobile device 645A and mobile device 645B (e.g., one or more cameras 710 and/or ambient light sensor 712) also capture environmental data describing light within the environment of the respective mobile device 645A and 645B.

In some embodiments, calibration software 720, server 130, or content delivery device 610 use the distance 810 or 830 to set picture quality adjustment settings. For example, calibration software 720 may instruct the user to position 645 at a location where the user normally views the display surface, so that distance 810 or 830 represents a typical viewing distance from the display surface. Picture adjustment 262 may select settings for edge control 314 based on the viewing distance, e.g., with a greater sharpness at the edges for a longer viewing distance, and lower sharpness for a shorter viewing distance. As another example, picture adjustment 262 may select settings for brightness control 312 based on the viewing distance, e.g., with higher brightness for a longer viewing distance, and lower brightness at a shorter viewing distance. Picture adjustment 262 may select other picture adjustment settings based on viewing distance.

In some embodiments, mobile device 645 may also detect the size of the display surface, e.g., a diagonal length, width, and/or height. Picture adjustment 262 may select settings for edge control 314, brightness control 312, or other picture quality settings based on the display surface size, e.g., with a greater sharpness at the edges for a smaller display surface.

### Example calibration screens for mobile device

FIGS. 9A, 9B and 9C, are three example display screens of a mobile device providing instructions to a user to assist in a calibration procedure, according to some embodiments of the disclosure. In this example, mobile device 645 outputs a user interface of calibration software 720 on display 716.

In FIG. 9A, the user interface includes a box 910 in which a user is to center a display surface, e.g., a television or a projector screen. A shaded area 920 around the box 910 helps do define the box 910. Calibration software 720 superimposes box 910 and shaded area 920 over an image captured by camera 710. Calibration software 720 may instruct a user to position mobile device 645 so that a field of view of camera 710 includes the display surface. Calibration software 720 may detect the display surface within the field of view of camera 710, e.g., using image detection. In this example, calibration software 720 may determine that the display surface is not centered within box 910, so instruction area 915 instructs the user to “arrange TV within box.”

In FIG. 9B, the user has moved the field of view of camera 710, as reflected in the changed position of the display surface on display 716. Calibration software 720 may detect that the display surface is now centered within box 910. In this example, calibration software 720 may be programmed to make sure that the display surface takes up most or all of box 910 (e.g., centered with 5% of a center point of box 910, and with display surface taking at least 90% of the surface area of box 910). In this example, instruction area 915 instructs the user to “move closer” to the display surface, so that display surface takes up a greater portion of box 910.

In FIG. 9C, the user has moved mobile device 645 closer to the display surface. Calibration software 720 determines that the display surface is now positioned and sized correctly, and mobile device 645 captures environmental data around 645. For example, cameras 710 capture one or more images, or ambient light sensor 712 capture ambient light data. Instruction area 915 provides feedback to the user that calibration software 720 has captured the calibration data. In some embodiments, calibration software 720 then provides additional instructions to the user to aid mobile device 645 in capturing additional data, e.g., data while mobile device 645 is positioned in a different direction (e.g., perpendicular to the direction in FIGS. 9A-9C, where camera 710 is directed at the display surface), or data while mobile device 645 is closer to or farther from the display surface.

In general, a calibration process may be designed to work on display surfaces of different sizes. In the example of FIGS. 9A-9C, to provide a consistent amount of light from the display surface to the camera 710, the calibration procedure is designed to ensure that the display surface is a specific size relative to mobile device 645. In other examples, the calibration process may be designed differently. For example, an alternate calibration procedure has mobile device 645 capture calibration data at a specific distance or range of distance (e.g., 1 meter away; between 2 meters and 3 meters away; etc.) from the display surface. In this example, calibration software 720 may use data from distance sensor 714 to instruct a user to move mobile device 645 forward or backward (i.e., closer to the display surface or farther from the display surface). In this example, calibration software 720 may also determine a display surface size based on the measured distance from the display surface and the relative size of the display surface within the field of view from camera 710.

### Example calibration procedure using mobile device

FIG. 10 is a flow diagram for determining a picture quality adjustment based on environmental data captured by a mobile device, according to some embodiments of the disclosure.

At 1002, mobile device 645 (e.g., calibration software 720) provides calibration instructions to the user, e.g., as shown in FIGS. 9A-9C. In some embodiments, content delivery device 610 alternatively or additionally provides calibration instructions on display device 615.

At 1004, display device 615 display a calibration image. During a calibration procedure, content delivery device 610 outputs a calibration image to display device 615 for display on the viewing surface. For example, while mobile device 645 is performing a calibration procedure, e.g., as shown in FIGS. 9A-9C, content delivery device 610 simultaneously displays a predetermined display used for calibration. The calibration image may be, e.g., a gray screen, a white screen, a test image, etc. In some embodiments, content delivery device 610 outputs the calibration image, or a pre-calibration image, while the calibration instructions are provided to the user, e.g., while the user is positioning mobile device 645; in such embodiments, the calibration image may assist calibration software 720 in determining whether mobile device 645 is positioned correctly.

In some embodiments, content delivery device 610 outputs a series of images on display device 615 during calibration. For example, after calibration software 720 determines that the display surface is positioned correctly within the field of view of camera 710 (e.g., as described with respect to FIGS. 9A-9C), calibration software 720 notifies server 130 or content delivery device 610; if calibration software 720 communicates with server 130, then server 130 notifies content delivery device 610 that mobile device 645 is ready for calibration. In response, content delivery device 610 outputs the calibration image or sequence of images.

At 1006, mobile device 645 captures environmental data. For example, as described above, cameras 710 and/or ambient light sensor 712 capture environmental data describing light in the environment of display device 615.

At 1008, content delivery device 610 (e.g., calibration 318 of picture adjustment 262) determines picture adjustments based on the captured data. For example, calibration 318 determines settings to be applied by color control 310, brightness control 312, edge control 314, or other picture quality adjustment modules. As an example, if ambient lighting in the room in which display device 615 is located has a warm color temperature, calibration 318 may determine to instruct color control 310 to cool content output by content delivery device 610 on display device 615, so that the overall coloration appears more neutral. As another example, calibration 318 may determine a brightness level for brightness control 312 to apply based on an overall ambient brightness in the room, e.g., increasing brightness in brighter rooms, and decreasing brightness in dimmer rooms. As another example, if calibration 318 determines that a user’s viewing distance from the display screen is relatively large (e.g., based on a distance measurement as described with respect to FIGS. 8A and 8B), calibration 318 may instruct edge control 314 to increase sharpness, to enhance viewability at the long viewing distance.

At 1010, content delivery device 610 receives content for display on display device 615. For example, content delivery device 610 receives content from server 130 or content store 140, as described above.

In 1012, content delivery device 610 adjusts picture quality of the content based on the retrieved settings. For example, picture adjustment 262 applies the picture quality adjustment settings determined by calibration 318. Picture adjustment 262 may adjust color (e.g., color temperature), brightness, edges, or other picture quality characteristics, as described above.

At 1014, content delivery device 610 transmits the adjusted content for display on display device 615.

### Example computing device

FIG. 11 depicts a block diagram of an exemplary computing device 1100, according to some embodiments of the disclosure. One or more computing devices, such as computing device 1100, may be used to implement the functionalities described with reference to the FIGS. and herein. A number of components are illustrated in the FIGS. as included in computing device 1100, but any one or more of these components may be omitted or duplicated, as suitable for the application. In some embodiments, some or all of the components included in the computing device 1100 may be attached to one or more motherboards. In some embodiments, some or all of these components are fabricated onto a single system on a chip (SoC) die. Additionally, in various embodiments, the computing device 1100 may not include one or more of the components illustrated in FIG. 11, and the computing device 1100 may include interface circuitry for coupling to the one or more components. For example, the computing device 1100 may not include a display device 1106, and may include display device interface circuitry (e.g., a connector and driver circuitry) to which a display device 1106 may be coupled. In another set of examples, the computing device 1100 may not include an audio input device 1118 or an audio output device 1108 and may include audio input or output device interface circuitry (e.g., connectors and supporting circuitry) to which an audio input device 1118 or audio output device 1108 may be coupled.

The computing device 1100 may include a processing device 1102 (e.g., one or more processing devices, one or more of the same type of processing device, one or more of different types of processing device). The processing device 1102 may include electronic circuitry that process electronic data from data storage elements (e.g., registers, memory, resistors, capacitors, quantum bit cells) to transform that electronic data into other electronic data that may be stored in registers and/or memory. Examples of processing device 1102 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 1100 may include a memory 1104, which may itself include one or more memory devices such as volatile memory (e.g., DRAM), non-volatile memory (e.g., read-only memory (ROM)), high bandwidth memory (HBM), flash memory, solid state memory, and/or a hard drive. Memory 1104 includes one or more non-transitory computer-readable storage media. In some embodiments, memory 1104 may include memory that shares a die with the processing device 1102. In some embodiments, memory 1104 includes one or more non-transitory computer-readable media storing instructions executable to perform operations described with the FIGS., such as operations described with software 204 (e.g., including one or more of: operating system 180, decoder 260, picture adjustment 262, and display interface 264). The instructions stored in the one or more non-transitory computer-readable media may be executed by processing device 1102. In some embodiments, memory 1104 may store data, e.g., data structures, binary data, bits, metadata, files, blobs, etc., as described with the FIGS. and herein.

In some embodiments, the computing device 1100 may include a communication device 1112 (e.g., one or more communication devices). For example, communication device 1112 may be configured for managing wired and/or wireless communications for the transfer of data to and from the computing device 1100. The term "wireless" and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 1112 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as "3GPP2"), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 1112 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 1112 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 1112 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 1112 may operate in accordance with other wireless protocols in other embodiments. The computing device 1100 may include an antenna 1122 to facilitate wireless communications and/or to receive other wireless communications (such as radio frequency transmissions). The computing device 1100 may include receiver circuits and/or transmitter circuits. In some embodiments, the communication device 1112 may manage wired communications, such as electrical, optical, or any other suitable communication protocols (e.g., the Ethernet). As noted above, communication device 1112 may include multiple communication chips. For instance, a first communication device 1112 may be dedicated to shorter-range wireless communications such as Wi-Fi or Bluetooth, and a second communication device 1112 may be dedicated to longer-range wireless communications such as global positioning system (GPS), EDGE, GPRS, CDMA, WiMAX, LTE, EV-DO, or others. In some embodiments, a first communication device 1112 may be dedicated to wireless communications, and a second communication device 1112 may be dedicated to wired communications.

The computing device 1100 may include power source / power circuitry 1114. The power source / power circuitry 1114 may include one or more energy storage devices (e.g., batteries or capacitors) and/or circuitry for coupling components of the computing device 1100 to an energy source separate from the computing device 1100 (e.g., DC power, AC power, etc.).

The computing device 1100 may include a display device 1106 (or corresponding interface circuitry, as discussed above). Display device 1106 may include any visual indicators, such as a heads-up display, a computer monitor, a projector, a touchscreen display, a liquid crystal display (LCD), a light-emitting diode display, or a flat panel display, for example.

The computing device 1100 may include an audio output device 1108 (or corresponding interface circuitry, as discussed above). The audio output device 1108 may include any device that generates an audible indicator, such as speakers, headsets, or earbuds, for example.

The computing device 1100 may include an audio input device 1118 (or corresponding interface circuitry, as discussed above). The audio input device 1118 may include any device that generates a signal representative of a sound, such as microphones, microphone arrays, or digital instruments (e.g., instruments having a musical instrument digital interface (MIDI) output).

The computing device 1100 may include a GPS device 1116 (or corresponding interface circuitry, as discussed above). The GPS device 1116 may be in communication with a satellite-based system and may receive a location of the computing device 1100, as known in the art.

The computing device 1100 may include a sensor 1130 (or one or more sensors). The computing device 1100 may include corresponding interface circuitry, as discussed above). Sensor 1130 may sense physical phenomenon and translate the physical phenomenon into electrical signals that can be processed by, e.g., processing device 1102. Examples of sensor 1130 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 1100 may include another output device 1110 (or corresponding interface circuitry, as discussed above). Examples of the other output device 1110 may include an audio codec, a video codec, a printer, a wired or wireless transmitter for providing information to other devices, haptic output device, gas output device, vibrational output device, lighting output device, home automation controller, or an additional storage device.

The computing device 1100 may include another input device 1120 (or corresponding interface circuitry, as discussed above). Examples of the other input device 1120 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1100 may have any desired form factor, such as a handheld or mobile computer system (e.g., a cell phone, a smart phone, a mobile internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 1100 may be any other electronic device that processes data.

### Select examples

Example 1 provides a method including receiving environmental data captured by a mobile device, the environmental data describing light within an environment of the mobile device, where a display device is within the environment of the mobile device; determining a picture quality adjustment setting for display of content on the display device based on the received environmental data; receiving content for display on the display device; applying the picture quality adjustment setting to the received content to generate adjusted content; and transmitting the adjusted content for display on the display device.

Example 2 provides the method of example 1, where the light within the environment of the mobile device includes light emitted by the display device.

Example 3 provides the method of example 1 or 2, the method further including instructing a display device to output a calibration display; where the light within the environment of the mobile device includes light emitted by the display device outputting the calibration display.

Example 4 provides the method of any of examples 1-3, where the environmental data includes data captured by an ambient light sensor of the mobile device.

Example 5 provides the method of any of examples 1-4, where the environmental data includes image data captured by at least one camera of the mobile device.

Example 6 provides the method of any of examples 1-5, further including receiving, from the display device, metadata describing the display device; and determining the picture quality adjustment setting for display of content on the display device further based on the metadata.

Example 7 provides the method of any of examples 1-6, where the picture quality adjustment setting applies a color adjustment to the received content.

Example 8 provides the method of any of examples 1-7, where the picture quality adjustment setting applies a brightness adjustment to the received content.

Example 9 provides the method of any of examples 1-8, further including receiving data describing a distance between the mobile device and the display device; and further determining the picture quality adjustment setting based on the distance between the mobile device and the display device.

Example 10 provides a method including instructing a user to position a mobile device in an environment of a display device; instructing the mobile device to capture environmental data, the environmental data describing light within the environment of the mobile device; determining a picture quality adjustment for display of content on the display device based on the captured environmental data; applying the picture quality adjustment to content to generate adjusted content; and transmitting the adjusted content to the display device for display by the display device.

Example 11 provides the method of example 10, where instructing the user to position the mobile device in the environment of the display device includes receiving a series of images captured by a camera of the mobile device, the camera having an image field; and outputting, in real time, the series of captured images and, overlaying the captured images, a box indicating a portion of the image field; and capturing the environmental data when the display device fills at least a threshold portion of the box.

Example 12 provides the method of example 10 or 11, where the environmental data further includes a distance from the mobile device to the display device, and the picture quality adjustment is further based on the distance.

Example 13 provides the method of any of examples 10-12, further including instructing the display device to output a calibration image, and instructing the mobile device to capture the environmental data while the display device is outputting the calibration image.

Example 14 provides a method including receiving, from a display device, metadata describing the display device; retrieving a picture quality adjustment setting based on the metadata; receiving content for display on the display device; applying the picture quality adjustment setting to the received content to generate adjusted content; and transmitting the adjusted content for display on the display device.

Example 15 provides the method of example 14, where the received content is encoded, the method further including decoding the content, and applying the picture quality adjustment setting to the decoded content.

Example 16 provides the method of example 14 or 15, where the metadata includes Extended Display Identification Data (EDID), Consumer Electronics Control (CEC) data, or Digital Living Network Alliance (DLNA) data transmitted from the display device.

Example 17 provides the method of any of examples 14-16, where the metadata includes data identifying a manufacturer of the display device, and the picture quality adjustment setting is determined based on the manufacturer of the display device.

Example 18 provides the method of example 17, where the picture quality adjustment setting is a first picture quality adjustment setting for the manufacturer, and a second picture quality adjustment setting different from the first picture quality adjustment setting is used for a second display device from a second manufacturer.

Example 19 provides the method of any of examples 14-19, where the picture quality adjustment setting applies a color adjustment to the received content.

Example 20 provides the method of example 19, where applying the picture quality adjustment setting adjusts a color temperature of the received content.

Example A provides one or more non-transitory computer-readable media storing instructions that, when executed by one or more processors, cause the one or more processors to perform any one of the methods described herein.

Example B provides an apparatus comprising means to carry out or means for carrying out any one of the methods provided in examples 1-20, and/or any one of the methods described herein.

Example C provides a computer-implemented system, comprising one or more processors, and one or more non-transitory computer-readable media storing instructions that, when executed by the one or more processors, cause the one or more processors to perform any one of the methods provided in examples 1-20 and/or any one of the methods described herein.

Example D provides a computer-implemented system comprising one or more components illustrated in any of FIGS. 1-3 or 6-9 to perform operations described herein.

Example E provides a computing device comprising one or more components illustrated in FIG. 11 to perform operations described herein.

### Variations and other notes

The description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the above detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase "A and/or B" means (A), (B), or (A and B). For the purposes of the present disclosure, the phrase “A, B, or C” or the phrase "A, B, and/or C" means (A), (B), (C), (A and B), (A and C), (B and C), or (A, B, and C). The term "between," when used with reference to measurement ranges, is inclusive of the ends of the measurement ranges.

The description uses the phrases "in an embodiment" or "in embodiments," which may each refer to one or more of the same or different embodiments. The terms "comprising," "including," "having," and the like, as used with respect to embodiments of the present disclosure, are synonymous. The disclosure may use perspective-based descriptions such as "above," "below," "top," "bottom," and "side" to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/- 20% of a target value as described herein or as known in the art. Similarly, terms indicating orientation of various elements, e.g., “coplanar,” “perpendicular,” “orthogonal,” “parallel,” or any other angle between the elements, generally refer to being within +/- 5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method comprising:
receiving environmental data captured by a mobile device, the environmental data describing light within an environment of the mobile device, wherein a display device is within the environment of the mobile device;
determining a picture quality adjustment setting for display of content on the display device based on the received environmental data;
receiving content for display on the display device;
applying the picture quality adjustment setting to the received content to generate adjusted content; and
transmitting the adjusted content for display on the display device.

2. The method of claim 1, wherein the light within the environment of the mobile device includes light emitted by the display device.

3. The method of claim 1, the method further comprising:
instructing a display device to output a calibration display;
wherein the light within the environment of the mobile device includes light emitted by the display device outputting the calibration display.

4. The method of claim 1, wherein the environmental data is captured by an ambient light sensor of the mobile device.

5. The method of claim 1, wherein the environmental data is image data captured by at least one camera of the mobile device.

6. The method of claim 1, further comprising:
receiving, from the display device, metadata describing the display device; and
determining the picture quality adjustment setting for display of content on the display device further based on the metadata.

7. The method of claim 1, wherein the picture quality adjustment setting applies a color adjustment to the received content.

8. The method of claim 1, wherein the picture quality adjustment setting applies a brightness adjustment to the received content.

9. The method of claim 1, further comprising:
receiving data describing a distance between the mobile device and the display device; and
further determining the picture quality adjustment setting based on the distance between the mobile device and the display device.

10. A method comprising:
instructing a user to position a mobile device in an environment of a display device;
instructing the mobile device to capture environmental data, the environmental data describing light within the environment of the mobile device;
determining a picture quality adjustment for display of content on the display device based on the captured environmental data;
applying the picture quality adjustment to content to generate adjusted content; and
transmitting the adjusted content to the display device for display by the display device.

11. The method of claim 10, wherein instructing the user to position the mobile device in the environment of the display device comprises:
receiving a series of images captured by a camera of the mobile device, the camera having an image field; and
outputting, in real time, the series of captured images and, overlaying the captured images, a box indicating a portion of the image field; and
capturing the environmental data when the display device fills at least a threshold portion of the box.

12. The method of claim 10, wherein the environmental data further comprises a distance from the mobile device to the display device, and the picture quality adjustment is further based on the distance.

13. The method of claim 10, further comprising instructing the display device to output a calibration image, and instructing the mobile device to capture the environmental data while the display device is outputting the calibration image.

14. A method comprising:
receiving, from a display device, metadata describing the display device;
retrieving a picture quality adjustment setting based on the metadata;
receiving content for display on the display device;
applying the picture quality adjustment setting to the received content to generate adjusted content; and
transmitting the adjusted content for display on the display device.

15. The method of claim 14, wherein the received content is encoded, the method further comprising decoding the content, and applying the picture quality adjustment setting to the decoded content.

16. The method of claim 14, wherein the metadata comprises Extended Display Identification Data (EDID), Consumer Electronics Control (CEC) data, or Digital Living Network Alliance (DLNA) data transmitted from the display device.

17. The method of claim 14, wherein the metadata comprises data identifying a
manufacturer of the display device, and the picture quality adjustment setting is determined
based on the manufacturer of the display device.

18. The method of claim 17, wherein the picture quality adjustment setting is a first picture quality adjustment setting for the manufacturer, and a second picture quality adjustment setting different from the first picture quality adjustment setting is used for a second display device from a second manufacturer.

19. The method of claim 14, wherein the picture quality adjustment setting applies a color adjustment to the received content.

20. The method of claim 19, wherein applying the picture quality adjustment setting adjusts a color temperature of the received content.
